(19) United States
(12) Patent Application Publication
(10) Pub. No.: US 2014/0369712 A1
(43) Pub. Date: Dec. 18, 2014

(54) IMAGE FORMING APPARATUS

(71) Applicant: Fuji Xerox Co., Ltd., Tokyo (JP)

(72) Inventors: Mitsuaki KURODA, Kanagawa (JP); Shiro SUZUKI, Kanagawa (JP); Akira HARADA, Kanagawa (JP)

(73) Assignee: Fuji Xerox Co., Ltd., Tokyo (JP)

(21) Appl. No.: 14/052,395

(22) Filed: Oct. 11, 2013

(30) Foreign Application Priority Data
Jun. 12, 2013 (JP) 2013-123666

(51) Int. Cl. G03G 21/20; G03G 15/00

(52) U.S. Cl. CPC G03G 21/20; G03G 15/65
USPC 399/94; 399/110

(57) ABSTRACT

An image forming apparatus includes a cooling device and a drawer. The cooling device includes two medium cooling members facing each other with a medium transport path therebetween, and a movable body moving the cooling members between a first position where they face each other and a second position where they are disposed away from each other. The drawer supports the transport path and the cooling device and is movable between a cooling-device accommodated position inside the apparatus and a cooling-device ejected position outside the apparatus. A transport-path length from an upstream end of the cooling device to a downstream end of the transport path in the movable body is longer than a length of a maximum-size medium. When the drawer and the movable body move to the accommodated position and the second position, respectively, the movable body is accommodated within a space within the apparatus.

### CROSS-REFERENCE TO RELATED APPLICATIONS

This application is based on and claims priority under 35 USC 119 from Japanese Patent Application No. 2013-123666 filed Jun. 12, 2013.

### BACKGROUND

### Technical Field

The present invention relates to image forming apparatuses.

### SUMMARY

According to an aspect of the invention, there is provided an image forming apparatus including a cooling device and a drawer body. The cooling device includes a pair of cooling members that are disposed facing each other with a medium transport path interposed therebetween and that come into contact with a medium so as to cool the medium, and a movable body that supports the cooling members and that moves the cooling members between a first position where one of the cooling members and the other cooling member face each other and a second position where the one cooling member and the other cooling member are disposed away from each other. The drawer body supports the medium transport path and the cooling device and is movable between an accommodation position where the cooling device is accommodated inside the image forming apparatus and a position where the cooling device is ejected from the image forming apparatus. A path length of the medium transport path extending in a medium transport direction from an upstream end of the cooling device to a downstream end of the medium transport path provided in the movable body is set to be longer than a length of a predetermined maximum-size medium usable in the image forming apparatus. When the drawer body moves to the accommodation position and the movable body moves to the second position, the movable body moved to the second position is accommodated within a space provided within the image forming apparatus.

### BRIEF DESCRIPTION OF THE DRAWINGS

An exemplary embodiment of the present invention will be described in detail based on the following figures, wherein:

FIG. 1 is an overall view of an image forming apparatus according to a first exemplary embodiment of the present invention;

FIG. 2 illustrates a relevant part of the image forming apparatus according to the first exemplary embodiment of the present invention;

FIGS. 3A and 3B illustrate a cooling device according to the first exemplary embodiment, as viewed from a side thereof, FIG. 3A illustrating the cooling device set in a cooling position and FIG. 3B illustrating the cooling device set in an open position;

FIG. 4 is a front view illustrating a state where the cooling device according to the first exemplary embodiment is set in the open position; and

FIG. 5 is a block diagram illustrating functions included in a controller of the image forming apparatus according to the first exemplary embodiment.

### DETAILED DESCRIPTION

Although an exemplary embodiment of the present invention will be described in detail below with reference to the drawings, the present invention is not to be limited to the following exemplary embodiment.

In order to provide an easier understanding of the following description, the front-rear direction will be defined as “X-axis direction” in the drawings, the left-right direction will be defined as “Y-axis direction”, and the up-down direction will be defined as “Z-axis direction”. Moreover, the directions or the sides indicated by arrows X, −X, Y, −Y, Z, and −Z are defined as forward, rearward, rightward, leftward, upward, and downward directions, respectively, or as front, rear, right, left, upper, and lower sides, respectively.

Furthermore, in each of the drawings, a circle with a dot in the center indicates an arrow extending from the far side toward the near side of the plane of the drawing, and a circle with an “x” therein indicates an arrow extending from the near side toward the far side of the plane of the drawing.

In the drawings used for explaining the following description, components other than those for providing an easier understanding of the description are omitted where appropriate.

### First Exemplary Embodiment

### Overall Configuration of Printer U According to First Exemplary Embodiment

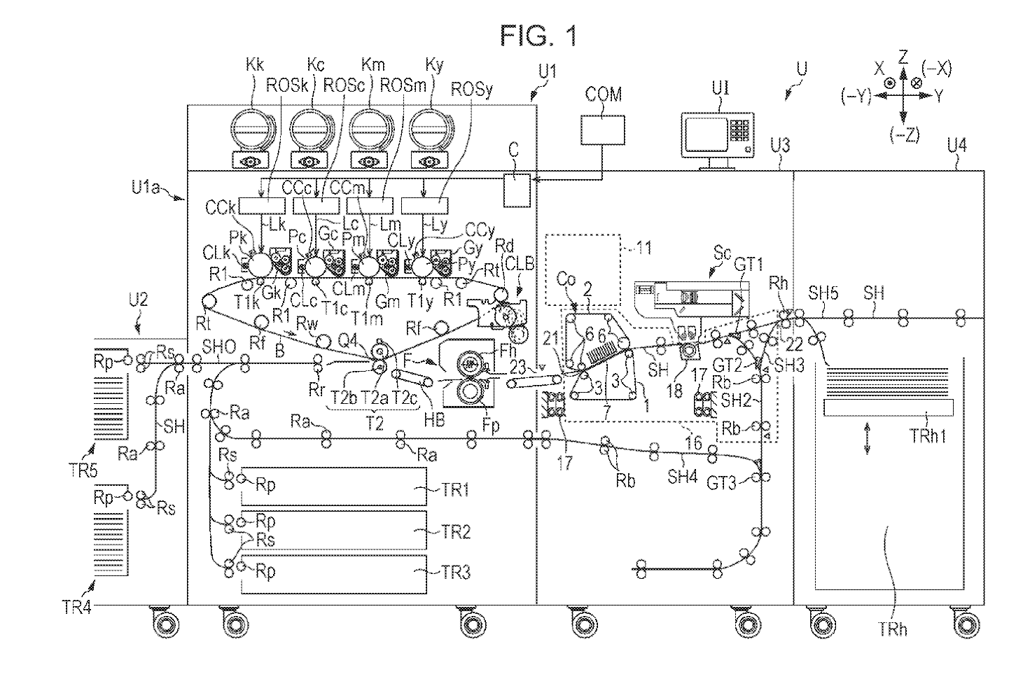

FIG. 1 is an overall view of an image forming apparatus according to a first exemplary embodiment of the present invention.

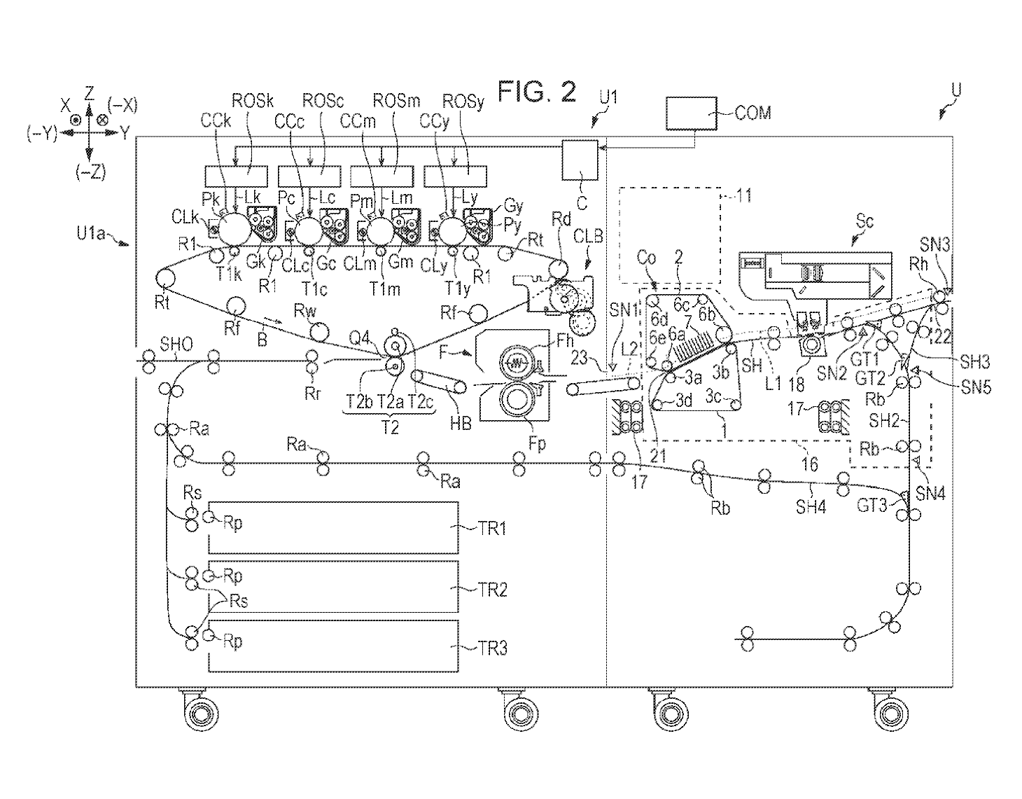

FIG. 2 illustrates a relevant part of the image forming apparatus according to the first exemplary embodiment of the present invention.

Referring to FIGS. 1 and 2, a printer U as an example of the image forming apparatus according to the first exemplary embodiment includes a printer body U1, a feeder unit U2 as an example of a feeding device that feeds a medium to the printer body U1, a processing unit U3 as an example of a post-processing device that performs processing on a medium having an image recorded thereon, an output unit U4 as an example of an output device to which the medium having the image recorded thereon is output, and an operable unit UI operable by a user.

Configuration of Marking Unit in First Exemplary Embodiment

Referring to FIGS. 1 and 2, the printer body U1 includes a controller C that controls the printer U, a communicator (not shown) that receives image information transmitted from a print image server COM as an example of an information transmitter externally connected to the printer U via a dedicated cable (not shown), and a marking unit U1a as an example of an image recorder that records an image onto a medium. The print image server COM is connected, via a line such as a cable or a local area network (LAN), to a personal computer PC as an example of an image transmitter that transmits information of an image to be printed in the printer U.

The marking unit U1a includes photoconductors Py, Pm, Pc, and Pk as an example of image bearing members for yellow (Y), magenta (M), cyan (C), and black (K) colors. The photoconductors Py to Pk have photoconductive dielectric surfaces.

Referring to FIGS. 1 and 2, in the rotational direction of the photoconductor Pk for the black color, a charger CCk, an exposure unit ROSk as an example of a latent-image forming unit, a developing unit Gk, a first-transfer roller T1k as an example of a first-transfer unit, and a photoconductor cleaner CLk as an example of an image-bearing-member cleaner are arranged around the photoconductor Pk.

Likewise, chargers CCy, CCm, and CCc, exposure units ROSy, ROSm, and ROSc, developing units Gy, Gm, and Gc, first-transfer rollers T1y, T1m, and T1c, and photoconductor cleaners CLy, CLm, and CLc are respectively arranged around the remaining photoconductors Py, Pm, and Pc.

Toner cartridges Ky, Km, Kc, and Kk as an example of containers that accommodate therein developers to be supplied to the developing units Gy to Gk are detachably supported above the marking unit U1a.

An intermediate transfer belt B as an example of an intermediate transfer body and an image bearing member is disposed below the photoconductors Py to Pk. The intermediate transfer belt B is interposed between the photoconductors Py to Pk and the first-transfer rollers T1y to T1k. The undersurface of the intermediate transfer belt B is supported by a drive roller Rd as an example of a drive member, a tension roller Rt as an example of a tension applying member, a working roller Rw as an example of a meander prevention member, multiple idler rollers Rf as an example of driven members, a backup roller T2a as an example of a second-transfer opposing member, multiple retracting rollers R1 as an example of movable members, and the aforementioned first-transfer rollers T1y to T1k.

A belt cleaner CLB as an example of an intermediate-transfer-body cleaner is disposed on the top surface of the intermediate transfer belt B near the drive roller Rd.

A second-transfer roller T2b as an example of a second-transfer member is disposed facing the backup roller T2a with the intermediate transfer belt B interposed therebetween. The backup roller T2a is in contact with a contact roller T2c as an example of a contact member for applying a voltage having a reversed polarity relative to the charge polarity of the developers to the backup roller T2a.

The backup roller T2a, the second-transfer roller T2b, and the contact roller T2c constitute a second-transfer unit T2 according to the first exemplary embodiment. The first-transfer rollers T1y to T1k, the intermediate transfer belt B, the second-transfer unit T2, and the like constitute a transfer device T1+B+T2 according to the first exemplary embodiment.

Feed trays TR1 to TR3 as an example of containers that accommodate therein recording sheets S as an example of media are provided below the second-transfer unit T2. A pickup roller Rp as an example of a fetching member and a separating roller Rs as an example of a separating member are disposed at the upper left side of each of the feed trays TR1 to TR3. A transport path SH that transports each recording sheet S extends from the separating roller Rs. Multiple transport rollers Ra as an example of transport members that transport each recording sheet S downstream are arranged along the transport path SH.

A registration roller Rr as an example of an adjusting member that adjusts the timing for transporting each recording sheet S toward the second-transfer unit T2 is disposed at the downstream side of the transport rollers Ra.

The feeder unit U2 is similarly provided with components, such as feed trays TR4 and TR5 that have configurations similar to those of the feed trays TR1 to TR3, the pickup rollers Rp, the separating rollers Rs, and the transport rollers Ra. A transport path SH from the feed trays TR4 and TR5 merges with the transport path SH in the printer body U1 at the upstream side of the registration roller Rr.

Multiple transport belts HB as an example of a medium transport device are arranged at the downstream side of the second-transfer roller T2b in the transport direction of the recording sheet S.

A fixing device F is disposed at the downstream side of the transport belts HB in the transport direction of the recording sheet S. The fixing device F includes a heating roller Fh as an example of a heating member and a pressing roller Fp as an example of a pressing member. The heating roller Fh accommodates therein a heater as an example of a heat source.

A cooling device Co is disposed within the processing unit U3 at the downstream side of the fixing device F.

An image reading device Sc that reads an image recorded on the recording sheet S is disposed at the downstream side of the cooling device Co.

A transport path SH extending toward the output unit U4 is formed at the downstream side of the image reading device Sc. An inversion path SH2 as an example of a transport path is formed inside the processing unit U3. The inversion path SH2 diverges downward from the transport path SH. A first gate GT1 as an example of a transport-direction switching member is disposed at the diverging point between the transport path SH and the inversion path SH2.

Multiple switchback rollers Rb as an example of transport members that are rotatable in forward and reverse directions are arranged along the inversion path SH2. A connection path SH3 as an example of a transport path that diverges from an upstream section of the inversion path SH2 and merges with the transport path SH at the downstream side of the diverging point of the inversion path SH2 is formed at the upstream side of the switchback rollers Rb. A second gate GT2 as an example of a transport-direction switching member is disposed at the diverging point between the inversion path SH2 and the connection path SH3.

A circulation path SH4 as an example of a transport path is disposed below the inversion path SH2. The circulation path SH4 diverges from the inversion path SH2, extends leftward, and merges with the transport path SH in the body U1 of the printer U at the upstream side of the registration roller Rr. Transport rollers Ra as an example of transport members are arranged along the circulation path SH4. A third gate GT3 as an example of a transport-direction switching member is disposed at the diverging point of the circulation path SH4 from the inversion path SH2.

In the output unit U4, a stacker tray TRh as an example of a container on which output recording sheets S are stacked is disposed, and an output path SH5 diverging from the transport path SH extends toward the stacker tray TRh. The transport path SH in the first exemplary embodiment is configured such that, when an additional output unit (not shown) or an additional post-processing device (not shown) is attached to the right side of the output unit U4, the transport path SH is capable of transporting the recording sheet S to the added unit or device.

Operation of Marking Unit

When the printer U receives image information transmitted from the personal computer PC via the print image server COM, the printer U commences a job, which is an image forming operation. When the job commences, the photoconductors Py to Pk, the intermediate transfer belt B, and the like rotate.

The photoconductors Py to Pk are rotationally driven by a drive source (not shown).

The chargers CCy to CCk receive a predetermined voltage so as to charge the surfaces of the photoconductors Py to Pk.

The exposure units ROSy to ROSk output laser beams Ly, Lm, Lc, and Lk as an example of latent-image write-in light in accordance with a control signal from the controller C so as to write electrostatic latent images onto the charged surfaces of the photoconductors Py to Pk.

The developing units Gy to Gk develop the electrostatic latent images on the surfaces of the photoconductors Py to Pk into visible images.

The toner cartridges Ky to Kk supply developers as the developers are consumed in the developing process performed in the developing units Gy to Gk.

The first-transfer rollers T1y to T1k receive a first-transfer voltage with a reversed polarity relative to the charge polarity of the developers so as to transfer the visible images on the surfaces of the photoconductors Py to Pk onto the surface of the intermediate transfer belt B.

The photoconductor cleaners CLy to CLk clean the surfaces of the photoconductors Py to Pk after the first-transfer process by removing residual developers therefrom.

When the intermediate transfer belt B passes through first-transfer regions facing the photoconductors Py to Pk, Y, M, C, and K images are transferred and superposed on the intermediate transfer belt B in that order, and the intermediate transfer belt B subsequently travels through a second-transfer region Q4 facing the second-transfer unit T2. When a monochrome image is to be formed, an image of a single color is transferred onto the intermediate transfer belt B and is transported to the second-transfer region Q4.

In accordance with the size of the received image information, the designated type of recording sheets S, and the sizes and types of accommodated recording sheets S, one of the pickup rollers Rp feeds recording sheets S from the corresponding one of the feed trays TR1 to TR5 from which the recording sheets S are to be fed.

The corresponding separating roller Rs separates the recording sheets S fed by the pickup roller Rp in a one-by-one fashion.

The registration roller Rr feeds the recording sheet S in accordance with a timing at which the image on the surface of the intermediate transfer belt B is transported to the second-transfer region Q4.

In the second-transfer unit T2, a predetermined second-transfer voltage having the same polarity as the charge polarity of the developers is applied to the backup roller T2a via the contact roller T2c so that the image on the intermediate transfer belt B is transferred onto the recording sheet S.

The belt cleaner CLB cleans the surface of the intermediate transfer belt B after the image transfer process performed at the second-transfer region Q4 by removing residual developers therefrom.

The recording sheet S having the image transferred thereon at the second-transfer unit T2 is transported downstream by the transport belts HB while being supported on the surfaces thereof.

The fixing device F heats and presses the recording sheet S passing through a fixing region where the heating roller Fh and the pressing roller Fp are in contact with each other so as to fix an unfixed image onto the surface of the recording sheet S.

The cooling device Co cools the recording sheet S heated by the fixing device F.

The image reading device Sc reads the image from the surface of the recording sheet S having passed through the cooling device Co. The read image may be compared with a document image so as to be used for, for example, detecting print errors or detecting misregistration of the image.

In the case of duplex printing, the recording sheet S having passed through the image reading device Sc is transported to the inversion path SH2 due to activation of the first gate GT1 and is switched back so as to be transported again to the registration roller Rr via the circulation path SH4, whereby printing is performed on the second face of the recording sheet S.

The recording sheet S to be output to the stacker tray TRh is transported along the transport path SH so as to be output onto the stacker tray TRh. In this case, if the recording sheet S to be output to the stacker tray TRh is in an inverted state, the recording sheet S is temporarily transported to the inversion path SH2 from the transport path SH. After the trailing edge of the recording sheet S in the transport direction thereof passes through the second gate GT2, the second gate GT2 is switched and the switchback rollers Rb are rotated in the reverse direction so that the recording sheet S is transported along the connection path SH3 toward the stacker tray TRh.

When multiple recording sheets S are stacked on the stacker tray TRh, a stacker plate TRhl automatically moves upward or downward in accordance with the number of stacked recording sheets S so that the uppermost sheet is disposed at a predetermined height.

Processing Unit U3

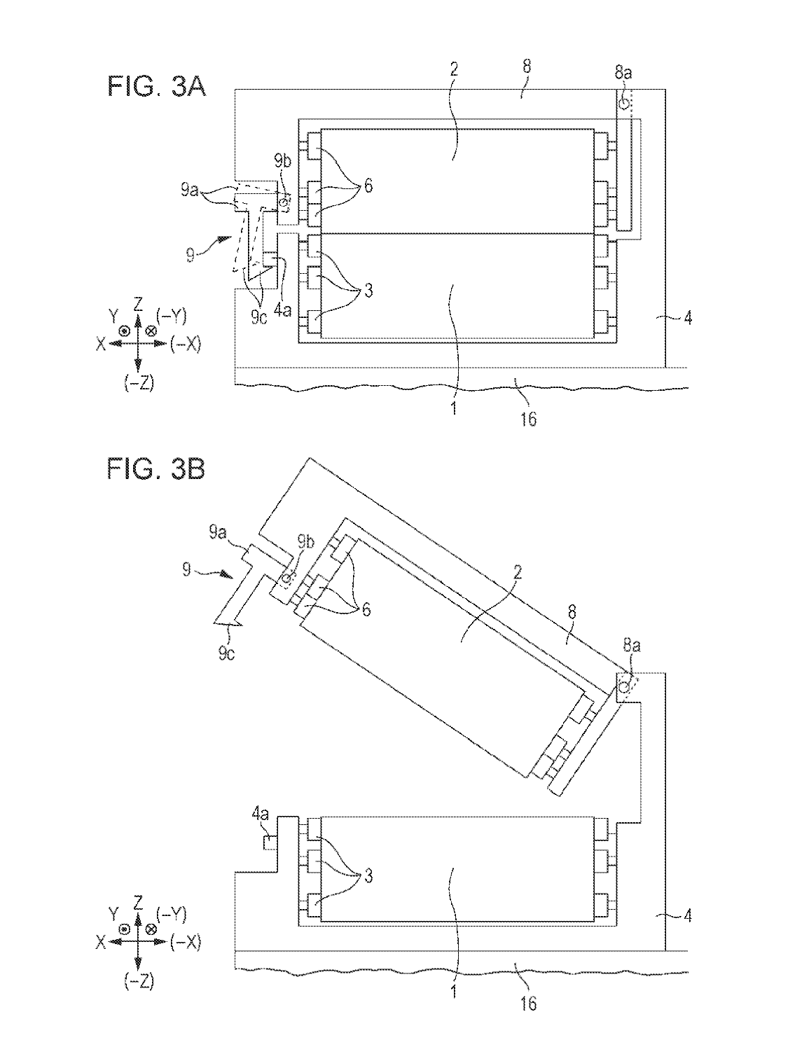

FIGS. 3A and 3B illustrate the cooling device Co according to the first exemplary embodiment, as viewed from a side thereof. Specifically, FIG. 3A illustrates the cooling device Co set in a cooling position, whereas FIG. 3B illustrates the cooling device Co set in an open position.

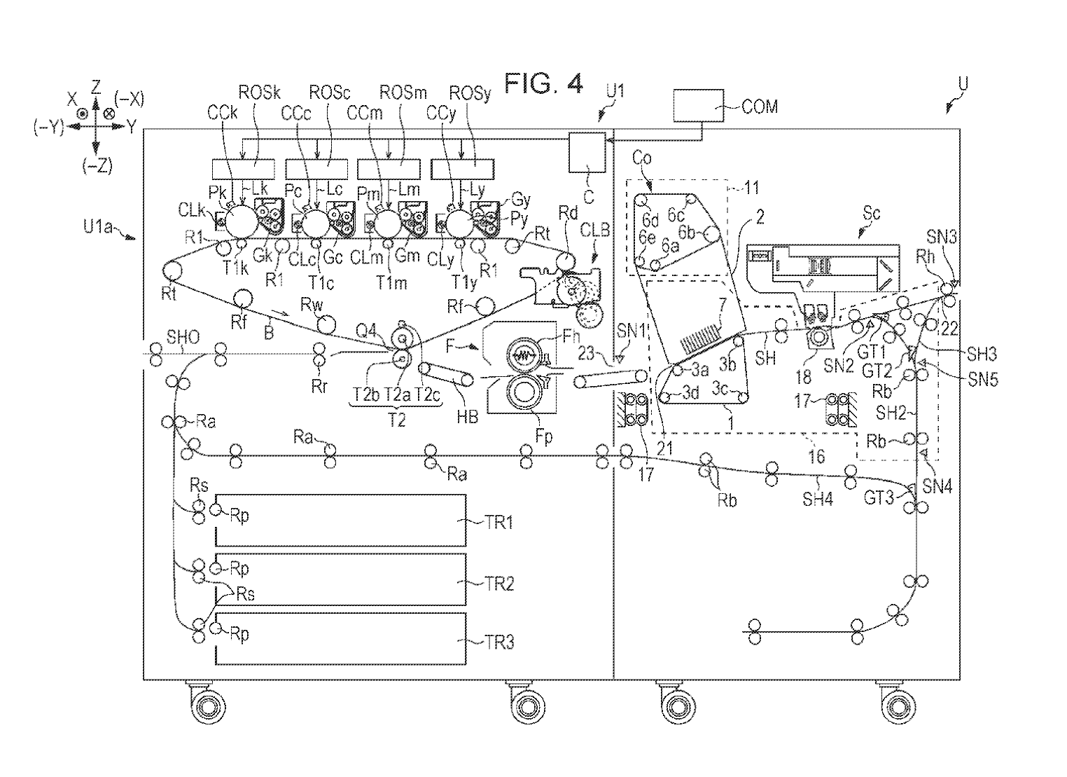

FIG. 4 is a front view illustrating a state where the cooling device Co according to the first exemplary embodiment is set in the open position.

Referring to FIGS. 1 to 3B, the cooling device Co according to the first exemplary embodiment includes a lower belt 1 and an upper belt 2 as examples of cooling members. The belts 1 and 2 are each formed of an endless belt-shaped member.

The lower belt 1 according to the first exemplary embodiment is wrapped around four lower rollers 3 as an example of support members.

The lower rollers 3 include a first lower roller 3a disposed at the upstream side of the transport path SH. A second lower roller 3b is disposed at the downstream side of the transport path SH relative to the first lower roller 3a. A third lower roller 3c is disposed below the second lower roller 3b. A fourth lower roller 3d is disposed at the left side of the third lower roller 3c as well as at the lower left side of the first lower roller 3a.

The lower rollers 3a to 3d are supported by a cooling frame 4 as an example of a cooling-device frame. A lock protrusion 4a as an example of a lock section is supported by the front end of the cooling frame 4. The fourth lower roller 3d receives a driving force from a motor as an example of a drive source (not shown), thereby rotating the lower belt 1.

The upper belt 2 is wrapped around five upper rollers 6 as an example of support members. The upper rollers 6 include a first upper roller 6a that faces the first lower roller 3a. A second upper roller 6b is disposed at a position facing the second lower roller 3b. A third upper roller 6c is disposed at the upper left side of the second upper roller 6b. A fourth upper roller 6d is disposed at the left side of the third upper roller 6c. A fifth upper roller 6e is disposed below the fourth upper roller 6d as well as at the upper left side of the first upper roller 6a.

A heat sink 7 as an example of a heat dissipating member is disposed between the first upper roller 6a and the second upper roller 6b. The heat sink 7 is supported in contact with the inner peripheral surface of the upper belt 2.

The upper rollers 6a to 6e and the heat sink 7 are supported by a rotatable frame 8 as an example of a movable body. The rotatable frame 8 is rotatably supported by the cooling frame 4 about a rotation shaft 8a provided at the rear end thereof. Therefore, the rotatable frame 8 is movable between the cooling position shown in FIG. 3A as an example of a first position and the open position shown in FIG. 3B as an example of a second position.

In the first exemplary embodiment, the fourth upper roller 6d receives a driving force from a motor as an example of a drive source (not shown), thereby rotating the upper belt 2.

Furthermore, in the cooling device Co according to the first exemplary embodiment, a spring (not shown) as an example of a biasing member is supported between the rotatable frame 8 and the cooling frame 4, such that the rotatable frame 8 is constantly biased upward. Therefore, the elastic force of the spring assists with the force used when releasing the rotatable frame 8, thereby reducing the force applied by an operator for manipulation.

A lock handle 9 as an example of a manipulable member is supported by the front end of the rotatable frame 8. The lock handle 9 has a handle portion 9a as an example of a manipulable portion. The handle portion 9a is rotatably supported by the rotatable frame 8 via a rear-end rotation shaft 9b. The handle portion 9a according to the first exemplary embodiment is manipulable by the operator. The lower surface of the handle portion 9a is provided with a lock claw 9c as an example of a releasing portion. The lock claw 9c extends from the handle portion 9a toward the lock protrusion 4a and is engageable with the lock protrusion 4a.

A torsion spring (not shown) as an example of an elastic member is fitted around the rotation shaft 9b of the lock handle 9 according to the first exemplary embodiment, such that the lock claw 9c is constantly biased in the engaging direction toward the lock protrusion 4a.

Referring to FIGS. 1, 2, and 4, in the processing unit U3 according to the first exemplary embodiment, a space 11 is provided above the upper belt 2. The space 11 has enough capacity for accommodating the upper belt 2 and the rotatable frame 8 when the front side of the upper belt 2 is moved upward by moving the rotatable frame 8 to the open position.

Referring to FIGS. 1 to 4, a drawer 16 as an example of a drawer body is disposed at an upper section of the processing unit U3. The drawer 16 according to the first exemplary embodiment is supported by a pair of left and right rails 17 in a movable manner in the front-rear direction relative to the processing unit U3.

The drawer 16 supports, for example, the cooling frame 4 of the cooling device Co, a lower medium transport section 18 constituting a part of the image reading device Sc, a part of the transport path SH and the inversion path SH2, the connection path SH3, and the gates GT1 and GT2. Therefore, when the drawer 16 is inserted into or ejected from the processing unit U3, the components supported by the drawer 16 move integrally therewith.

In the processing unit U3 according to the first exemplary embodiment, a path length L1 extending from an upstream end 21, where the belts 1 and 2 of the cooling device Co are in contact with each other, to a downstream end 22 of the transport path SH supported by the processing unit U3 is set to be longer than the length of a predetermined maximum-size medium usable in the printer U. For example, if the usable maximum-size medium is A3 and short edge feed (SEF) is to be performed, the path length L1 is set to be longer than 420 mm, which is the length of A3-SEF in the transport direction.

Furthermore, in the processing unit U3 according to the first exemplary embodiment, a path length L2 from the upstream end 21 to an inlet 23 of the processing unit U3 is set to be shorter than the length of the maximum-size medium. In the processing unit U3 according to the first exemplary embodiment, sheet sensors SN1 to SN5 as an example of medium detectors are disposed. In the processing unit U3 according to the first exemplary embodiment, the first sheet sensor SN1 is disposed near the upstream end 21. The second sheet sensor SN2 is disposed near the diverging point between the transport path SH and the inversion path SH2 in the processing unit U3. The third sheet sensor SN3 is disposed near an outlet of the transport path SH in the processing unit U3. The fourth sheet sensor SN4 is disposed at the lower end of the inversion path SH2 supported by the drawer 16. The fifth sheet sensor SN5 is disposed at the upstream end of the connection path SH3. In the printer U according to the first exemplary embodiment, although multiple sheet sensors (not shown) are disposed along the transport path SH and the like, such sheet sensors are not shown for avoiding complexity of the description. Moreover, the positions and the number of sheet sensors are arbitrarily changeable in accordance with, for example, design and specifications.

Controller According to First Exemplary Embodiment

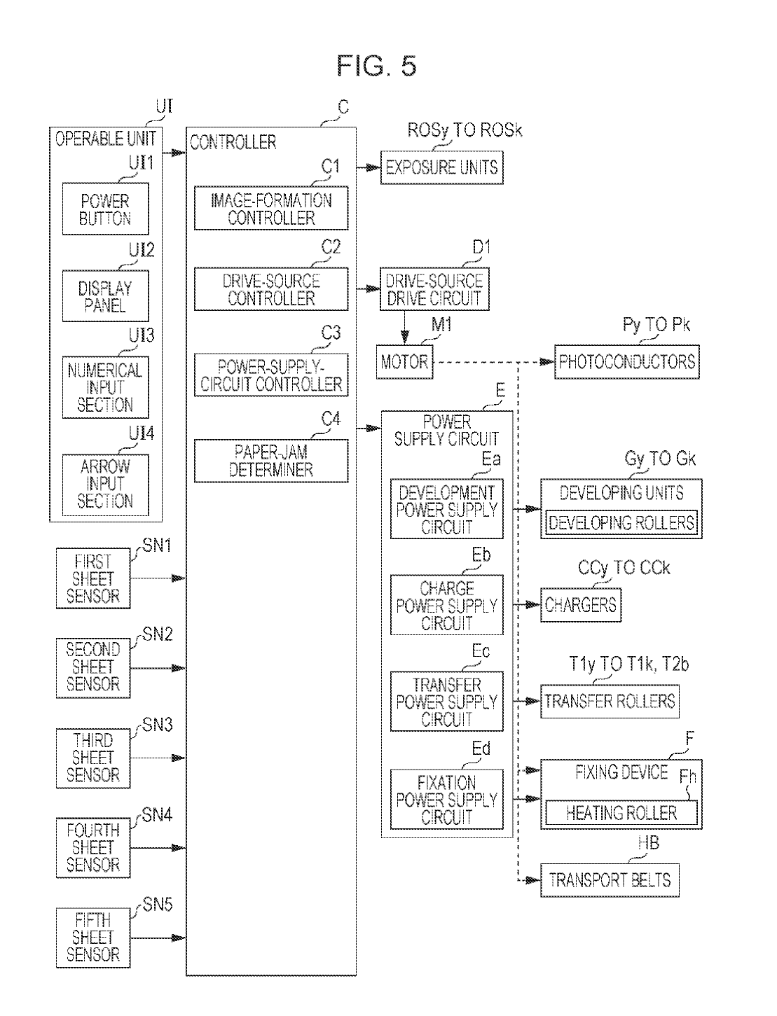

FIG. 5 is a block diagram illustrating functions included in the controller C of the image forming apparatus according to the first exemplary embodiment.

Referring to FIG. 5, the controller C of the printer body U1 includes an input/output interface I/O that exchanges signals with the outside. The controller C also includes a read-only memory (ROM) that stores, for example information as well as programs for executing processing. Moreover, the controller C includes a random access memory (RAM) that temporarily stores data. Furthermore, the controller C includes a central processing unit (CPU) that performs processing in accordance with a program stored in, for example, the ROM. Therefore, the controller C according to the first exemplary embodiment is constituted of a small information processor, namely, a so-called microcomputer. Thus, the controller C is capable of achieving various functions by executing the programs stored in, for example, the ROM.

Signal Output Components Connected to Controller C of Printer Body U1

The controller C of the printer body U1 receives output signals from signal output components, such as the operable unit UI and the sheet sensors SN1 to SN5.

The operable unit UI includes a power button UI1 as an example of a power switch, a display panel UI2 as an example of a display, a numerical input section U13, and an arrow input section UI4.

The sheet sensors SN1 to SN5 detect a sheet S passing through the positions of the sheet sensors SN1 to SN5. Controlled Components Connected to Controller C of Printer Body U1

The controller C of the printer body U1 is connected to a drive-source drive circuit D1, a power supply circuit E, and other controlled components (not shown). The controller C outputs control signals to, for example, the circuits D1 and E.

The drive-source drive circuit D1 rotationally drives, for example, the photoconductors Py to Pk and the intermediate transfer belt B via a motor M1 as an example of a drive source.

The power supply circuit E includes a development power supply circuit Ea, a charge power supply circuit Eb, a transfer power supply circuit Ec, and a fixation power supply circuit Ed.

The development power supply circuit Ea applies development voltage to developing rollers of the developing units Gy to Gk.

The charge power supply circuit Eb applies charge voltage to the chargers CCy to CCk so as to charge the surfaces of the photoconductors Py to Pk.

The transfer power supply circuit Ec applies transfer voltage to the first-transfer rollers T1y to T1lk and the second-transfer roller T2b.

The fixation power supply circuit Ed supplies electric power for heating the heating roller Fh of the fixing device F.

Function of Controller C of Printer Body U1

The controller C of the printer body U1 has a function of executing processing according to input signals from the signal output components and outputting control signals to the controlled components. Specifically, the controller C has the following functions.

An image-formation controller C1 controls, for example, the driving of each component in the printer U and the voltage application timing in accordance with image information input from the personal computer PC so as to execute a job, which is an image forming operation.

A drive-source controller C2 controls the driving of the motor M1 via the drive-source drive circuit D1 so as to control the driving of, for example, the photoconductors Py to Pk.

A power-supply-circuit controller C3 controls the power supply circuits Ea to Ed so as to control the voltage to be applied to each component and the electric power to be supplied to each component.

A paper-jam determiner C4 determines whether or not a paper jam has occurred on the basis of detection results of the sheet sensors SN1 to SN5. The paper-jam determiner C4 according to the first exemplary embodiment also determines the position where a paper jam has occurred on the basis of the detection results of the sheet sensors SN1 to SN5. Specifically, for each of the sheet sensors SN1 to SN5, the paper-jam determiner C4 according to the first exemplary embodiment determines whether or not the recording sheet S has reached the position of the sheet sensor SN1 to SN5 after a first predetermined time has elapsed in accordance with the transport speed of the recording sheet S. In other words, if the recording sheet S should have already reached the position of one of the sheet sensors SN1 to SN5 and should be detected by the one of the sheet sensors SN1 to SN5 but the recording sheet S is still not detected, the paper-jam determiner C4 determines that a paper jam has occurred at the upstream side of the one of the sheet sensors SN1 to SN5.

Furthermore, the paper-jam determiner C4 according to the first exemplary embodiment determines whether or not the recording sheet S has passed through each of the sheet sensors SN1 to SN5 after a second predetermined time has elapsed since the recording sheet S has been detected by each of the sheet sensors SN1 to SN5. Specifically, if the recording sheet S should have already passed through the position of one of the sheet sensors SN1 to SN5 and should not be detected by the one of the sheet sensors SN1 to SN5 but the recording sheet S is still continuously detected, the paper-jam determiner C4 determines that a paper jam has occurred at the position of the one of the sheet sensors SN1 to SN5.

Accordingly, the position where a paper jam has occurred is identifiable on the basis of the determination results of the sheet sensors SN1 to SN5.

Accordingly, the paper-jam determiner C4 according to the first exemplary embodiment is capable of determining whether a paper jam has occurred and where the paper jam has occurred. Moreover, if a paper jam has occurred on the basis of the determination results, the paper-jam determiner C4 according to the first exemplary embodiment makes the display panel UI2 display a message indicating the occurrence of the paper jam and the position where the paper jam has occurred.

Operation of Processing Unit U3 According to First Exemplary Embodiment

In the processing unit U3 of the printer U according to the first exemplary embodiment having the above-described configuration, when an image forming operation is to be executed, the cooling position shown in FIGS. 1 and 2 is maintained. In the cooling position, as shown in FIG. 3A, the lock claw 9c is engaged with the lock protrusion 4a so that the rotatable frame 8 is maintained in the cooling position. Therefore, the upper belt 2 is maintained so as to face the lower belt 1 and be in contact therewith. Thus, with the rotation of the belts 1 and 2, the recording sheet S is transportable downstream, and the recording sheet S heated at the fixing device F is cooled as the recording sheet S is transported in contact with the belts 1 and 2.

If the recording sheet S becomes jammed in the transport path SH inside the processing unit U3, the occurrence of the paper jam and the paper-jam position are detected. When removing the jammed recording sheet S, if the drawer 16 is ejected in a state where the recording sheet S extends astride the drawer 16 and a section other than the drawer 16, the recording sheet S may possibly rip. If the recording sheet S rips, the removal process becomes troublesome or a portion thereof may remain inside without being removed, possibly leading to, for example, reoccurrence of a paper jam.

In the processing unit U3 according to the first exemplary embodiment, the path length L1 from the upstream end 21 to the downstream side is set to be longer than the length of the maximum-size recording sheet S. Therefore, based on the position of a paper jam, if the paper jam occurs in the transport path SH within the processing unit U3 and the trailing edge of the recording sheet S is passing through the upstream end 21, the recording sheet S would be contained within the drawer 16. Therefore, the recording sheet S would not extend astride the drawer 16 and the section other than the drawer 16. Thus, by ejecting the drawer 16 forward, the recording sheet S is readily removable.

Furthermore, in the processing unit U3 according to the first exemplary embodiment, if a paper jam occurs in the transport path SH within the processing unit U3 and the trailing edge of the recording sheet S is not passing through the upstream end 21, there is a possibility that the recording sheet S is in a state where it extends astride the drawer 16 and the section other than the drawer 16.

In this case, if a paper jam occurs in a known configuration in which a recording sheet is transported by using a pair or rollers, the recording sheet may be forcibly fed by using an entrance roller. However, in the configuration provided with the belts 1 and 2 according to the first exemplary embodiment, the belts 1 and 2 are flexible. Therefore, even if the recording sheet were to be forcibly fed from upstream, the belts 1 and 2 may tend to deform. Thus, the recording sheet is less likely to buckle, and the recording sheet may press against the belts 1 and 2 and possibly damage the belts 1 and 2. Therefore, with the configuration having the belts 1 and 2, it may be difficult to employ the configuration of forcibly feeding the recording sheet. Consequently, when a paper jam occurs at the belts 1 and 2, if the sheet is to be removed by ejecting the drawer 16, the sheet may possibly rip.

In contrast, in the processing unit U3 according to the first exemplary embodiment, the space 11 is provided so that the upper belt 2 is releasable from the lower belt 1. Specifically, by manipulating the lock handle 9, the upper belt 2 is movable to the open position shown in FIGS. 3B and 4 without having to eject the drawer 16. Thus, the recording sheet S interposed between the belts 1 and 2 is removable without having to eject the drawer 16. Consequently, the occurrence of ripping of the recording sheet S is reduced in the configuration having the belts 1 and 2.

Furthermore, in the first exemplary embodiment, the rotation shaft 8a of the rotatable frame 8 is disposed at the rear end of the processing unit U3. Thus, when the rotatable frame 8 is moved to the open position, the front side of the belts 1 and 2 may be widely opened so as to provide a better view of the inside, as compared with a configuration in which the rotation shaft is provided at the upstream side or the downstream side in the transport direction or a configuration in which the rotatable frame is upwardly slidable. This may facilitate the removal process of a jammed sheet.

Moreover, in the first exemplary embodiment, the upper and lower sides of the cooling device Co are constituted of the belts 1 and 2 so that the area in contact with a passing recording sheet S may be increased, thereby achieving improved cooling efficiency, as compared with a case where the upper and lower sides of the cooling device Co are constituted of rollers.

### Modifications

Although the exemplary embodiment of the present invention has been described in detail above, the present invention is not to be limited to the above exemplary embodiment and permits various modifications within the technical scope of the invention defined in the claims. Modifications H01 to H05 will be described below.

In a first modification H01, the image forming apparatus according to the above exemplary embodiment is not limited to the printer U, but may be, for example, a copier, a facsimile apparatus, or a multifunction apparatus having multiple or all functions of such apparatuses.

In the above exemplary embodiment, the printer U is configured to use developers of four colors. Alternatively, in a second modification H02, the above exemplary embodiment may be applied to, for example, a monochrome image forming apparatus or a multicolor image forming apparatus that uses three colors or fewer, or five colors or more.

In a third modification H03, the specific numerical values and parameters described as examples in the above exemplary embodiment are arbitrarily changeable in accordance with, for example, design and specifications.

Although the rotation shaft 8a is disposed at the rear side of the drawer 16 in the ejecting direction thereof in the above exemplary embodiment, the position of the rotation shaft 8a is not limited to this. Specifically, in a fourth modification H04, the rotation shaft 8a may be disposed at the upstream side or the downstream side in the transport direction.

In the above exemplary embodiment, when the belts 1 and 2 are to be opened or closed, the upper belt 2 is configured to be rotationally moved. Alternatively, in a fifth modification H05, for example, the lower belt 1 may be configured to be rotated downward, or both the lower belt 1 and the upper belt 2 may be configured to be rotationally moved. As other alternatives, one of the belts 1 and 2 may be configured to slide vertically relative to the other belt, or both belts may be configured to move toward and away from each other in the vertical direction.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a cooling device including
a pair of cooling members that are disposed facing each other with a medium transport path interposed therebetween and that come into contact with a medium so as to cool the medium, and
a movable body that supports the cooling members and that moves the cooling members between a first position where one of the cooling members and the other cooling member face each other and a second position where the one cooling member and the other cooling member are disposed away from each other; and
a drawer body that supports the medium transport path and the cooling device and that is movable between an accommodation position where the cooling device is accommodated inside the image forming apparatus and a position where the cooling device is ejected from the image forming apparatus, wherein a path length of the medium transport path extending in a medium transport direction from an upstream end of the cooling device to a downstream end of the medium transport path provided in the movable body is set to be longer than a length of a predetermined maximum-size medium usable in the image forming apparatus,
wherein, when the drawer body moves to the accommodation position and the movable body moves to the second position, the movable body moved to the second position is accommodated within a space provided within the image forming apparatus.

2. The image forming apparatus according to claim 1, wherein the movable body is supported in a movable manner between the first position and the second position about a rotation shaft disposed at a rear side of the drawer body in a direction in which the drawer body is accommodated.

3. The image forming apparatus according to claim 1, wherein the cooling members are formed of endless belt-shaped members.
